(19) United States
(12) Patent Application Publication
(10) Pub. No.: US 2005/0091215 A1
(43) Pub. Date: Apr. 28, 2005

(54) Technique for provisioning storage for servers in an on-demand environment

(76) Inventors: Tushar Deepak Chandra, Palo Alto, CA (US); Pawan Goyal, San Jose, CA (US)

Correspondence Address: JOSEPH P. CURTIN, 1469 N.W. MORGAN LANE, PORTLAND, OR, 97229, US

(21) Appl. No.: 10/673,755

(22) Filed: Sep. 29, 2003

(51) Int. Cl. G06F 17/30; G06F 7/00

(52) U.S. Cl. 707/10

(57) ABSTRACT

Servers and storage in a Storage Area Network (SAN) are dynamically allocated to a system user, such as a customer or an application, by identifying at least one master storage image that is in the storage and that will be associated with a system user when a server is allocated to the system user is identified. A plurality of replicas of each identified master storage image is generated prior to at least one server being allocated to the system user. A selected replica of the plurality of replicas of the master storage image is allocated to each server allocated to the system user. Each time a server is de-allocated, the corresponding replica is de-allocated and assigned to a pool of de-allocated replicas. The pool of de-allocated replicas is configured to automatically scrub all replicas, such as by reformatting, when the number of de-allocated replicas equals a predetermined number.

### BACKGROUND OF THE INVENTION

1. Field of the Invention

The present invention relates to data storage systems. More particularly, the present invention relates to a system and a method for allocating and de-allocating servers in a Storage Area Network (SAN).

2. Description of the Related Art

Servers in Intranet and Internet data-centers, commonly referred to as on-demand servers, are significantly over-provisioned and, consequently, have a relatively low utilization rate. One conventional solution for managing storage in an on-demand server environment having multiple servers is to associate dedicated disks (local disks or Storage Area Network (SAN)—attached disks) with each respective server. All of the state data that is required for a server is copied onto a disk at the time that the disk is dedicated to the server and added to a cluster of dedicated disks associated with a server. A significant amount of time may be required to copy the state data onto the newly added disk. Accordingly, the total time required to allocate a server to a system user can be significant when a conventional dedicated-disk-and-an-all-state-data-copy allocation technique is used. As used herein, the term “system user” means a customer and/or an application.

Additionally, each dedicated disk must be scrubbed, that is, state data associated with a system user removed, when the server is de-allocated to avoid a leak of confidential data between system users. Consequently, a further increase in time is required when a dedicated disk is de-allocated. The large amounts of time that are required for allocation and de-allocation of a server results in a significant under-utilization of resources. See, for example, A. Chandra et al., “Quantifying the benefits of resource multiplexing in on-demand data centers,” Proceedings of the First ACM Workshop on Algorithms and Architectures for Self-Managing Systems (Self-Manage 2003), June 2003. Thus, a conventional dedicated-disk-and-an-all-state copy allocation technique is desirable only when the amount of persistent state data is small.

Another conventional allocation and de-allocation technique that is used for some on-demand server systems is a Network File System (NFS) server for the entire state data. Although such a technique reduces the overall time required for allocation and de-allocation, there are, nevertheless, disadvantages. For example, NFS performance is lower than the performance of a local file system. Additionally, a NFS server can not be conveniently shared among multiple system users because there are security issues, as well as potential user identification (userid) conflicts.

Consequently, what is needed is an allocation and de-allocation technique for an on-demand system that reduces the time required for allocating and de-allocating servers for a system user.

### BRIEF SUMMARY OF THE INVENTION

The present invention provides an allocation and de-allocation technique for an on-demand system that reduces the time required for allocating and de-allocating servers for a system user.

The advantages of the present invention are provided by a system and a method of allocating storage to a system user, such as a customer or an application, of a storage area network that includes storage and a plurality of servers accessing the storage. According to the invention, at least one master storage image that is in the storage and that will be associated with a system user when a server is allocated to the system user is identified. The master storage image is pre-configured with data and state information that is associated with a system user. A plurality of replicas of each identified master storage image is generated prior to at least one server being allocated to the system user. Each replica is a logical volume. A selected replica of the plurality of replicas is allocated to each server allocated to the system user. Each time a server is de-allocated, the corresponding replica is de-allocated and assigned to a pool of de-allocated replicas. The pool of de-allocated replicas is configured to automatically scrub all replicas, such as by reformatting, asynchronously when, for example, the number of de-allocated replicas assigned to the pool equals a predetermined number.

The present invention also provides a system and a method for allocating storage between system users of a storage area network that includes storage and a plurality of servers accessing the storage. At least one master storage image that is stored in the storage of the storage area network and that will be associated with a system user is identified. Each master storage image includes both a read-only data portion and a writeable data portion. A read-only copy of the read-only data portion of each master storage image is generated and shared across the plurality of servers. The read-only copy of the read-only data portion of a selected master storage image is allocated to each server that is allocated to the system user. A separate writable data volume of the writable data portion of the selected master storage image is allocated to each server allocated to the system user. When a server that has been allocated to the system user is de-allocated, the read-only copy of the read-only data portion of the selected master image is de-allocated from the de-allocated server. The writable data volume allocated to the server that has been de-allocated is de-allocated and assigned to a pool of de-allocated writable data volumes that is automatically scrubbed, such as by reformatting, asynchronously from the de-allocation of the writable data volume when, for example, the amount of writable data volumes assigned to the pool equals a predetermined amount.

### BRIEF DESCRIPTION OF THE DRAWINGS

The present invention is illustrated by way of example and not by limitation in the accompanying figures in which like reference numerals indicate similar elements and in which:

FIG. 1 shows a functional block diagram of an exemplary on-demand server system that utilizes allocation and de-allocation technique of the present invention;

FIG. 2 shows a flow diagram for an exemplary method of allocating storage to a system user of a storage area network according to the present invention;

FIG. 3 shows a flow diagram of another exemplary method of allocating storage between system users of a storage area network according to the present invention; and

FIG. 4 shows a functional block diagram of an exemplary on-demand server system that utilizes the exemplary method of allocating storage between system users of a storage area shown in FIG. 3.

### DETAILED DESCRIPTION OF THE INVENTION

The present invention increases server utilization for an on-demand system by dynamically sharing servers between multiple system users. The number of servers and the amount of storage allocated to a particular system user is dynamically changed based on the traffic received by the on-demand system.

The following description of the present invention will use web/application servers as exemplary servers because web/application servers have two types of persistent state data, mostly-read-only state data, such as html files, and mostly-write state data that is local to the server, such as logs. It should be kept in mind, though, that the servers that are dynamically allocated by the present invention may be used for a variety of purposes, such as web servers, application servers, databases, etc., and are not limited to the exemplary web/application servers that are described herein.

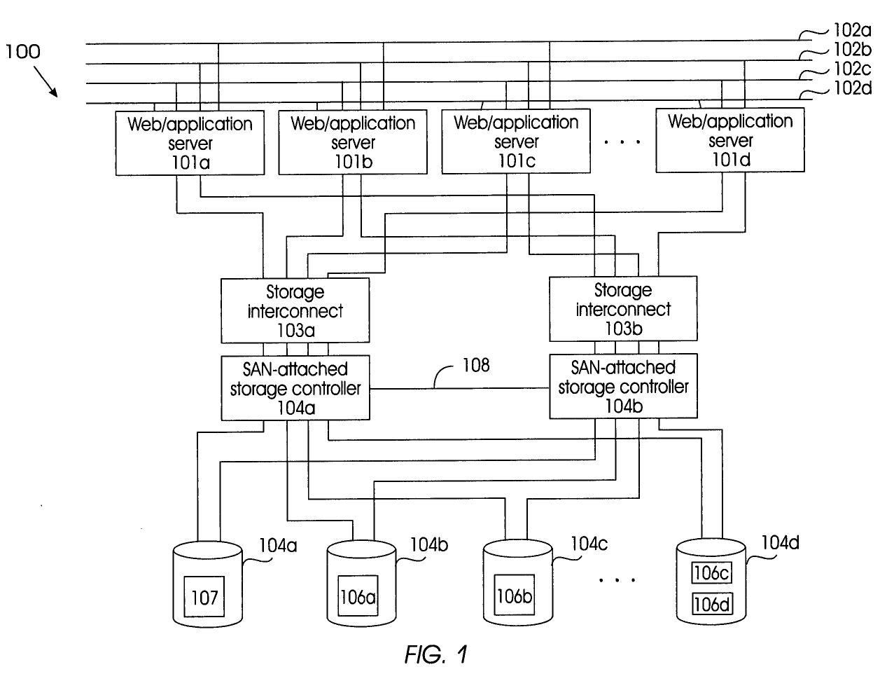

FIG. 1 shows a functional block diagram of an exemplary on-demand server system 100 that utilizes allocation and de-allocation technique of the present invention. On-demand server system 100 is configured as a Storage Area Network (SAN) and includes web/application servers 101-101d. Web/application servers 101a-101d are connected to multiple network interconnects 102a-102d and to multiple storage interconnects 103a and 103b. Storage interconnects 103a and 103b are connected to a plurality of data storage devices 105a-105b through SAN-attached storage controllers 104a and 104b. SAN-attached storage controllers 104a and 104b communicate in a well-known manner through communication link 108 to coordinate storage control. While FIG. 1 shows exemplary on-demand server system 100 as having only four web/application servers 101a-101d, four network interconnects 102a-102d, two storage interconnects 103a and 103b, two SAN-attached storage controllers 104a and 104b, and four data storage devices 105a-105d, it should be understood that on-demand server system 100 can have any number of web/application servers, network interconnects, storage interconnects, SAN-attached storage controllers, and storage devices.

All servers 101a-101d are dynamically allocated by virtue of being connected to on-demand server system 100, which is configured as a SAN. In a conventional SAN environment, every server can undesirably access every logical drive in the SAN environment unless additional measures are taken. In contrast to a conventional SAN environment, the present invention restricts a system user so that each system user can access only the particular set of logical drives that have been allocated to the system user. Inter- and intra-system user security and access controls are dynamically implemented by SAN-attached storage controllers 104a and 104b that use SAN Logical Unit Number (LUN) masking and SAN zoning. That is, SAN-attached storage controllers 104a and 104b restrict system user access using LUN masking to a set of logical drives corresponding to servers allocated to the system user. SAN zoning provides an additional level of security by creating virtual networks for each system user so that only the ports and devices that are required to access the logical drives allocated to the system user belong to the specified zone for the system user.

To reduce the time necessary for allocating and de-allocating web/application servers to a system user, the present invention utilizes a pre-configuration technique by creating a predetermined number X of replicas 106a-106d of a master storage image 107 for a system user, such that each replica is a logical drive within the SAN. A master storage image can contain, for example, a boot image, application code and/or data, web pages, etc. More than one replica can be stored on a storage unit because each storage unit can contain more than one logical drive. When a new server is allocated to a system user, one of the replicas is also allocated to the server. The logical drive containing the allocated replica serves as the local hard disk for the system user on which all persistent application state data is stored. When a server is de-allocated from the system user, each logical drive that has been allocated to the system user is de-allocated and added to a pool of logical drives that must be scrubbed. For example, let Y be the maximum number of disks in the pool that must be scrubbed. By appropriately selecting a number X of replicas for each user and a number Y of disks in the pool that must be scrubbed for the overall system, a server is not required to wait for (1) data to be copied when the server is being allocated to a system user or (2) allocated disk to be scrubbed when the server is being de-allocated, thereby desirably reducing the total time of the allocation and de-allocation process.

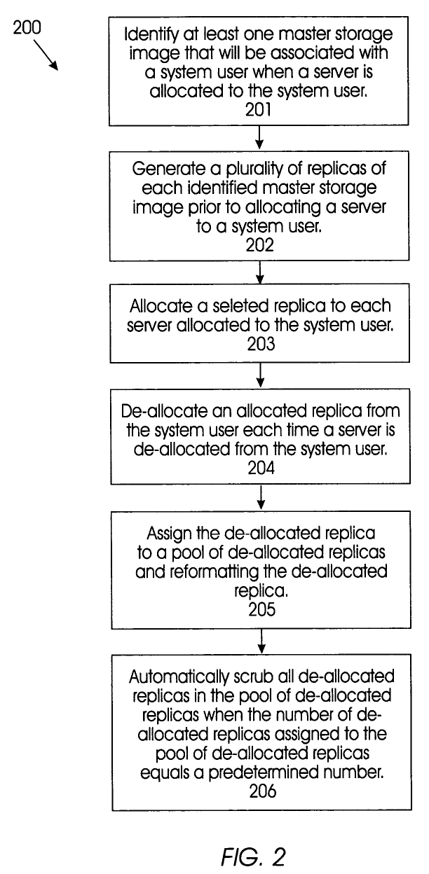

FIG. 2 shows a flow diagram 200 for an exemplary method of allocating storage to a system user of a storage area network according to the present invention. At step 201, at least one master storage image 107 that is stored in the storage of the storage area network 100, shown in FIG. 1, and that will be associated with a system user, such as a customer or an application, when a server 101 is allocated to the system user is identified. Master storage image 107 is pre-configured with data and state information that is associated with a system user. At step 202, a plurality of replicas 106a-106d of each identified master storage image 107 is generated prior to at least one server 101 being allocated to the system user. Each replica 106 is a logical volume. At step 203, a selected replica of replicas 106 is allocated to each server 101 that is allocated to the system user. At step 204, an allocated replica 106 is de-allocated from the system user each time a server 101 is de-allocated from the system user. At step 205, the de-allocated replica is assigned to a pool of de-allocated replicas. At step 206, the pool of de-allocated replicas is configured to automatically scrub all replicas in the pool, such as by reformatting, asynchronously from de-allocation when, for example, a number of de-allocated replicas assigned to the pool equals a predetermined number.

A drawback that is associated with pre-configuring X replicas for a system user is that more disks are used than are strictly necessary. To overcome this drawback, the present invention reduces the disk space requirement by exploiting the fact that a significant amount of data is read-only data. The present invention separates the persistent application state data into mostly read-only state data and read-write state data. The read-only state data is stored on a single logical drive that is shared by all servers. All of the servers mount the logical drive having read-only state data as a read-only file system. The read-write state data that is local to each server is stored on a separate logical drive for each server and is de-allocated and scrubbed when the server is de-allocated. Zoning keeps one system user from accessing read-only state data and writable state data of another system user even though a single logical drive is shared by multiple system users.

Read-only data sharing according to the present invention is as fast as a conventional pre-configuration technique for allocation and de-allocation, but requires significantly less disk space than a conventional pre-configuration technique. In that regard, the disk-space requirement of the read-only state data sharing technique of the present invention is comparable to disk-space requirement of a conventional Network-Attached Storage device (NAS) technique.

The read-only state data sharing technique of the present invention requires a special technique for updating the read-only state data, such as when html files in a web-server are updated. To handle update of read-only state data, the new read-only state data is created on a new logical drive, that is, a logical drive that has not yet been allocated. The currently allocated read-only logical drive is then changed to the new logical drive by rebooting the servers belonging to a cluster one-at-a-time, thereby ensuring that the cluster for the server is always up and with at most one server being down at any time.

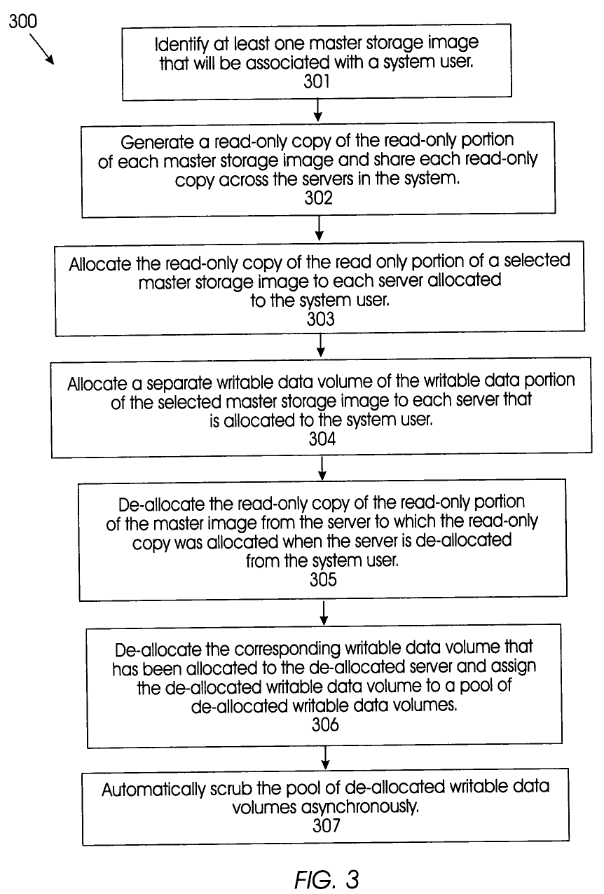

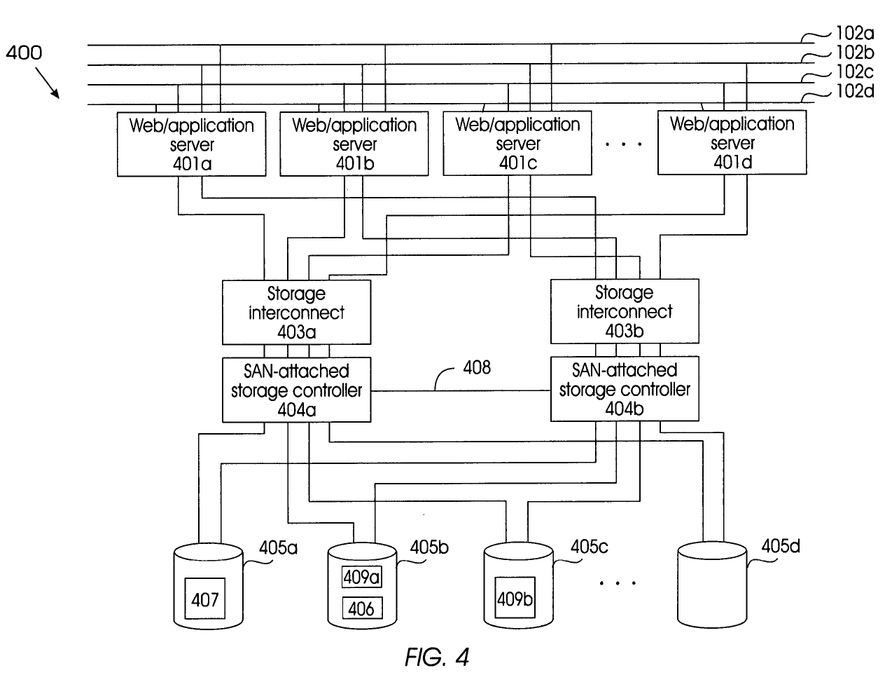

FIG. 3 shows a flow diagram 300 of another exemplary method of allocating storage between system users of a storage area network according to the present invention. FIG. 4 shows a functional block diagram of an exemplary on-demand server system 400 that utilizes the exemplary method of allocating storage between system users of a storage area shown in FIG. 3. On-demand server system 400 is configured as a Storage Area network (SAN) and includes web/application servers 401a-401d. Web/application servers 401a-401d are connected to multiple network interconnects 402a-402d and to multiple storage interconnects 403a and 403b . Storage interconnects 403a and 403b are connected to a plurality of data storage devices 405a-405b through SAN-attached storage controllers 404a and 404b. SAN-attached storage controllers 104a and 104b communicate in a well-known manner through communication link 108 to coordinate storage control. While FIG. 4 shows exemplary on-demand server system 400 as having only four web/application servers 104a-104d, four network interconnects 402a-402d, two storage interconnects 403a and 403b, two SAN-attached storage controllers 404a and 404b, and four data storage devices 405a-405d, it should be understood that on-demand server system 400 can have any number of web/application servers, network interconnects, storage interconnects, SAN-attached storage controllers, and storage devices.

At step 301 in FIG. 3, at least one master storage image 407 that is stored in the storage devices 405 of storage area network 400 and that will be associated with a system user is identified. Each master storage image 407 includes both a read-only data portion and a writeable data portion. At step 302, a read-only copy of the read-only data portion of each master storage image is generated and is shared across all of the servers. While only a single master storage image 407 and a single read-only copy 406 is shown in FIG. 4, additional master storage images and corresponding read-only copies of the respective master storage images can exist in storage devices 405. At step 303, the read-only copy 406 of the read-only data portion a selected master storage image 407 is allocated to each server that is allocated to a system user. At step 304, a separate writable data volume 409 of the writable data portion of the selected master storage image 407 is allocated to each server that is allocated to the system user. For example, in FIG. 4, consider the situation in which servers 104aand 401b and read-only copy 406 have been allocated to a system user. Servers 104aand 401b are respectively allocated writable data volumes 409a and 409b. At step 305, when a server is de-allocated from the system user, the corresponding read-only copy 406 is de-allocated from the server that has been de-allocated. At step 306, the corresponding writable data volume that has been allocated to the de-allocated server is de-allocated and assigned to a pool of de-allocated writable data volumes. At step 307, the pool of de-allocated writable data volumes is configured to automatically scrub all writable state data in the pool, such as by reformatting, asynchronously from the de-allocation of the writable data volume when, for example, the amount of writable data volumes assigned to the pool equals a predetermined amount.

Although the foregoing invention has been described in some detail for purposes of clarity of understanding, it will be apparent that certain changes and modifications may be practiced that are within the scope of the appended claims. Accordingly, the present embodiments are to be considered as illustrative and not restrictive, and the invention is not to be limited to the details given herein, but may be modified within the scope and equivalents of the appended claims.

1. A method of allocating storage to a system user of a storage area network, the storage area network including storage and a plurality of servers accessing the storage, the method comprising steps of:
identifying at least one master storage image that is stored in the storage of the storage area network and that will be associated with a system user when a server is allocated to the system user;
generating a plurality of replicas of each identified master storage image prior to at least one server being allocated to the system user; and
allocating a selected replica of the plurality of replicas of the master storage image to each server allocated to the system user.

2. The method according to claim 1, further comprising steps of:
de-allocating an allocated replica from the system user each time a server is de-allocated from the system user; and
assigning the de-allocated replica to a pool of de-allocated replicas.

3. The method according to claim 2, wherein the pool of de-allocated replicas is configured to automatically scrub all replicas in the pool of de-allocated replicas asynchronously from de-allocation the step of de-allocation.

4. The method according to claim 3, wherein the pool of de-allocated replicas is scrubbed when a number of de-allocated replicas assigned to the pool of de-allocated replicas equals a predetermined number.

5. The method according to claim 3, wherein the pool of de-allocated replicas is automatically scrubbed by reformatting.

6. The method according claim 1, wherein each replica is a logical volume.

7. The method according to claim 1, wherein the system user is one of a customer and an application.

8. The method according to claim 1, wherein the master storage image is pre-configured with data and state information that is associated with a system user.

9. A method of allocating storage between system users of a storage area network, the storage area network including storage and a plurality of servers accessing the storage, the method comprising steps of:
identifying at least one master storage image that is stored in the storage of the storage area network and that will be associated with a system user, each master storage image including both a read-only data portion and a writeable data portion;
generating a read-only copy of the read-only data portion of each master storage image;
sharing the read-only data copy of the read-only data portion of each master storage image across the plurality of servers;
allocating the read-only copy of the read-only data portion of a selected master storage image to each server allocated to the system user; and
allocating a separate writable data volume of the writable data portion of the selected master storage image to each server allocated to the system user.

10. The method according to claim 9, further comprising steps of:
de-allocating the read-only copy of the read-only data portion of the selected master image from the server to which the read-only copy was allocated when the server is de-allocated from the system user; and
de-allocating the writable data volume of the writable data portion of the selected master storage image that was allocated to the de-allocated server.

11. The method according to claim 10, wherein the step of de-allocating the writable data volume includes the steps of:
assigning the de-allocated writable data volume to a pool of de-allocated writable data volumes; and
scrubbing any writable data volumes assigned to the pool of de-allocated writable data volumes asynchronously from the step of de-allocating the writable data volume.

12. A storage area network, comprising:
a plurality of servers coupled to a storage; and
a storage provisioning device coupled to the servers and allocating at least one server and a portion of the storage to a system user, the storage provisioning device identifying at least one master storage image that is stored in the storage and that will be associated with a system user when a server is allocated to the system user, the storage provisioning device further generating a plurality of replicas of each identified master storage image prior to at least one server being allocated to the system user; and allocating a selected replica of the plurality of replicas of the master storage image to each server allocated to the system user.

13. The storage area network according to claim 12, wherein the storage provisioning device de-allocates an allocated replica from the system user each time a server is de-allocated from the system user removes a server, and assigns the de-allocated replica to a pool of de-allocated replicas.

14. The storage area network according to claim 13, wherein the pool of de-allocated replicas automatically scrubs all replicas in the pool of de-allocated replicas asynchronously from de-allocation the step of de-allocation.

15. The storage area network according to claim 14, wherein the pool of de-allocated replicas is scrubbed when a number of de-allocated replicas assigned to the pool of de-allocated replicas equals a predetermined number.

16. The storage area network according to claim 14, wherein the pool of de-allocated replicas is automatically scrubbed by reformatting.

17. The storage area network according claim 12, wherein each replica is a logical volume.

18. The storage area network according to claim 12, wherein the system user is one of a customer and an application.

19. The storage area network according to claim 12, wherein storage provisioning device pre-configures the master storage image with data and state information that is associated with a system user.

20. A storage area network, comprising:
a plurality of servers coupled to a storage; and
a storage provisioning device coupled to the servers and allocating at least one server and a portion of the storage to a system user, the storage provisioning device identifying at least one master storage image that is stored in the storage of the storage area network and that will be associated with a system user, each master storage image including both a read-only data portion and a writeable data portion, the storage provisioning device further generating a read-only copy of the read-only portion of each master storage image and sharing the read-only copy of the read-only portion of each master storage image across the plurality of servers, allocating the read-only copy of the read-only portion of a selected master storage image to each server allocated to the system user, and allocating a separate writable data volume of the writable data portion of the selected master storage image to each server allocated to the system user.

21. The storage area network according to claim 20, wherein the storage provisioning device de-allocates the read-only copy of the read-only portion of the master image from the server to which the read-only copy was allocated when the server is de-allocated from the system user, and de-allocates the writable data volume allocated to the server that has been de-allocated.

22. The storage area network according to claim 21, wherein when the storage provisioning device de-allocates the writable data volume, assigns the de-allocated writable data volume to a pool of de-allocated writable data volumes and scrubs any writable data volumes assigned to the pool of de-allocated writable data volumes asynchronously from when the storage provisioning device de-allocates the writable data volume.
